(19) United States
(12) Patent Application Publication
(10) Pub. No.: US 2026/0142352 A1
(43) Pub. Date: May 21, 2026

(54) SECONDARY BATTERY HAVING BENT STRIP TERMINAL AND METHOD AND APPARATUS FOR MANUFACTURING THE SAME

(71) Applicant: SAMSUNG SDI CO., LTD., Yongin-si (KR)

(72) Inventors: Donghyun KIM, Yongin-si (KR); Yejin SEO, Yongin-si (KR); Eunjeong MOON, Yongin-si (KR)

(21) Appl. No.: 19/235,968

(22) Filed: Jun. 12, 2025

(30) Foreign Application Priority Data
Oct. 8, 2024 (KR) 10-2024-0137177

(51) Int. Cl. H01M 50/553; H01M 50/566

(52) U.S. Cl. CPC H01M 50/553; H01M 50/566

(57) ABSTRACT

A secondary battery includes an exterior material of the secondary battery, an electrode assembly accommodated in the exterior material, the electrode assembly including a plurality of electrode plates on which there are electrode tabs, and a strip terminal including a welded portion welded to the electrode tabs and a bent portion bent within the exterior material, wherein a bending angle of the bent portion of the strip terminal is 90° or less.

### CROSS-REFERENCE TO RELATED APPLICATION

This application claims priority to and the benefit of Korean Patent Application No. 10-2024-0137177, filed on Oct. 8, 2024, the disclosure of which is incorporated herein by reference in its entirety.

### BACKGROUND

### 1. Field

The present disclosure relates to a secondary battery having a bent strip terminal and a method and apparatus for manufacturing the same.

### 2. Description of the Related Art

Batteries include primary batteries that are not rechargeable and secondary batteries that can be charged and discharged. Low-capacity secondary batteries are used in portable small electronic devices such as smartphones, feature phones, laptop computers, digital cameras, and camcorders, whereas large-capacity secondary batteries are widely used as power sources for driving motors in hybrid vehicles, electric vehicles, and the like as well as for power storage batteries. A secondary battery includes an electrode assembly formed of a positive electrode and a negative electrode, an exterior material such as a case or can for accommodating the electrode assembly, and external terminals electrically connected to the electrode assembly.

The above information disclosed in this Background section is for enhancement of understanding of the background of the present disclosure, and therefore, it may contain information that does not constitute a related (or prior) art.

### SUMMARY

Embodiments include a secondary battery, including an exterior material, an electrode assembly accommodated in the exterior material, the electrode assembly including a plurality of electrode plates on which there are electrode tabs, and a strip terminal including a welded portion welded to the electrode tabs and a bent portion bent within the exterior material, wherein a bending angle of the bent portion of the strip terminal is 90° or less.

The bent portion of the strip terminal may include a portion excluding the welded portion.

The secondary battery may further include a tab film bonded to the strip terminal.

The exterior material may be an external pouch of a pouch-type secondary battery.

The exterior material may be an external can of a prismatic secondary battery.

Embodiments include a method of manufacturing a secondary battery, the method including providing an electrode assembly including a plurality of electrode plates with electrode tabs formed thereon, forming a welded portion by welding a strip terminal to the electrode tabs formed on the plurality of electrode plates of the electrode assembly, bending the strip terminal at an angle of 90° or less, resulting in a bent strip terminal, bending the electrode tabs, resulting in bent electrode tabs, and accommodating the electrode assembly with the bent strip terminal and the bent electrode tabs inside an exterior material.

Bending the strip terminal at the angle of 90° or less may include bending a portion excluding the welded portion.

Bending the strip terminal at the angle of 90° or less may include supporting the welded portion with a support jig, and bending the strip terminal at a bending angle of 90° or less by pressing the strip terminal with a bending jig having two arms forming an internal angle of 90° or less.

Bending the strip terminal at the angle of 90° or less may further include supporting the electrode tabs with a front guide in a direction opposite to a direction in which the support jig supports the welded portion.

Bending the electrode tabs may include pushing the welded portion of the strip terminal bent at the bending angle of 90° or less toward the electrode assembly.

Accommodating the electrode assembly in the exterior material may include accommodating the electrode assembly inside an external pouch of a pouch-type secondary battery.

Accommodating the electrode assembly in the exterior material may include accommodating the electrode assembly inside an external can of a prismatic secondary battery.

Embodiments include an apparatus for manufacturing a secondary battery, the apparatus including a welding unit configured to form a welded portion by welding a strip terminal to electrode tabs formed on a plurality of electrode plates included in an electrode assembly, a bending jig configured to bend the strip terminal at a bending angle of 90° or less, and a support jig configured to support the welded portion of the strip terminal when the bending jig bends the strip terminal and push the welded portion of the strip terminal bent by the bending jig toward the electrode assembly to bend the electrode tabs.

The bending jig may bend a portion of the strip terminal excluding the welded portion.

The bending jig may include two arms having an internal angle of 90° or less in order to press and bend the strip terminal at the bending angle of 90° or less.

The apparatus may further include a front guide configured to support the electrode tabs in a direction opposite to a direction in which the support jig supports the welded portion.

The bending jig may be configured to be moved away from the strip terminal after the support jig bends the electrode tabs.

The support jig may be configured to support a lower portion of the welded portion of the strip terminal at same angle as the internal angle of the bending jig.

### BRIEF DESCRIPTION OF THE DRAWINGS

Features will become apparent to those of ordinary skill in the art by describing in detail exemplary embodiments with reference to the attached drawings, in which:

FIG. 1 is a schematic diagram illustrating an electrode assembly of a secondary battery;

FIG. 2 is a schematic diagram illustrating a pouch-type secondary battery to which the electrode assembly manufactured according to some embodiments of the present disclosure is applicable;

FIG. 3 is a cross-sectional view illustrating an inside of the electrode assembly accommodated in a pouch in the pouch-type secondary battery of FIG. 2;

FIG. 4A is a diagram illustrating a bending structure of a strip terminal of the secondary battery according to some embodiments of the present disclosures;

FIG. 4B is a diagram illustrating a bending structure of a strip terminal of the secondary battery according to some other embodiments of the present disclosures;

FIGS. 5A to 5F are diagrams for describing a method of bending a strip terminal according to some embodiments of the present disclosure;

FIG. 6 is a diagram illustrating a strip terminal bending jig and a support jig according to some other embodiments of the present disclosure;

FIG. 7 is a diagram illustrating a strip terminal bending jig and a support jig according to some other embodiments of the present disclosure; and

FIG. 8 is a schematic diagram illustrating a prismatic secondary battery to which the electrode assembly manufactured according to some embodiments of the present disclosure is applicable.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

It will be further understood that the terms “includes,” “including,” “comprises,” and/or “comprising,” if used in this specification, specify the presence of stated features, integers, steps, operations, elements, and/or components but do not preclude the presence or addition of one or more other features, integers, steps, operations, elements, components, and/or groups thereof.

References to two compared elements, features, etc. as being “the same” may mean that they are “substantially the same.” Thus, the phrase “substantially the same” may include a case having a deviation that is considered low in the art, for example, a deviation of 5% or less. In addition, uniformity of a parameter in a predetermined region may imply uniformity from an average perspective.

Although the terms first, second, and the like are used to describe various components, these components are substantially not limited by these terms. These terms are only used for distinguishing one component from another component, and unless otherwise stated, it is of course that a first component may also be a second component.

Throughout the specification, unless otherwise stated, each element may be singular or plural.

Arranging an arbitrary element “above (or below)” or “on (under)” another element may mean that the arbitrary element may contact the upper (or lower) surface of the element, and another element may also be interposed between the element and the arbitrary element located on (or under) the element.

In addition, it will be understood that if a component is referred to as being “linked,” “coupled,” or “connected” to another component, the elements may be directly “coupled,” “linked” or “connected” to each other, or another component may be “interposed” between the components.”

As used herein, the term “and/or” includes any and all combinations of one or more of the associated listed items. Further, the use of “may” if describing embodiments of the present disclosure relates to “one or more embodiments of the present disclosure.” Expressions such as “one or more” and “one or more” preceding a list of elements modify the full list of elements and do not modify individual elements in the list.

Throughout the specification, if “A and/or B” is stated, it means A, B or A and B, unless otherwise stated and if “C to D” is stated, it means C or more and D or less, unless otherwise stated.

When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C.

As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below.

The terminology used herein is for the purpose of describing embodiments of the present disclosure and is not intended to limit the present disclosure.

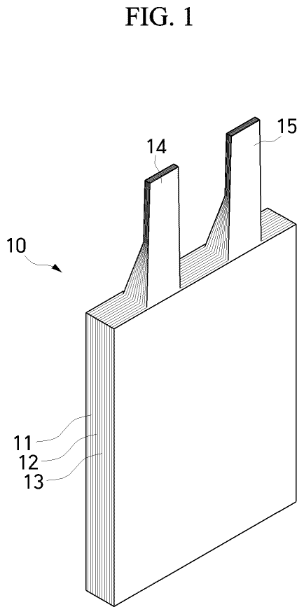

FIG. 1 is a schematic diagram illustrating an example of an electrode assembly of a secondary battery.

Referring to FIG. 1, an electrode assembly 10 may be formed by stacking a first electrode plate 11, a separator 12, and a second electrode plate 13 (e.g., the separator 12 is between the first electrode plate 11 and the second electrode plate 13), each of which are formed as thin plates or sheets. In other embodiments, the electrode assembly 10 may be a wound-type rather than the stacked-type, and the shape of the electrode assembly 10 may vary. In addition, the electrode assembly 10 may be a Z-stack electrode assembly in which a positive electrode plate and a negative electrode plate are inserted into both sides (e.g., opposite sides) of a separator, which is then bent (or folded) into a Z-stack. The first electrode plate 11 of the electrode assembly may act as a negative electrode, and the second electrode plate 13 may act as a positive electrode. Of course, the reverse is also possible.

The first electrode plate 11 (e.g., a negative electrode) may be formed by applying (e.g., coating or depositing) a first electrode active material, such as graphite or carbon, onto a first electrode substrate formed of a metal foil, such as copper, a copper alloy, nickel, or a nickel alloy. The first electrode plate 11 may include a first electrode tab 14 (e.g., a first uncoated portion), which is a region to which the first electrode active material is not applied. The first electrode tabs 14 of the electrode plates may be welded and electrically connected to an external first terminal.

The second electrode plate 13 (e.g., a positive electrode plate) may be formed by applying (e.g., coating or depositing) a second electrode active material, such as a transition metal oxide, onto a second electrode substrate formed of a metal foil, such as aluminum or an aluminum alloy. The second electrode plate 13 may include a second electrode tab 15 (e.g., a second uncoated portion), which is a region to which the second electrode active material is not applied. Also, the second electrode tabs 15 of the electrode plates may be welded and electrically connected to an external second terminal.

The separator 12 prevents a short-circuit between the first electrode plate 11 and the second electrode plate 13 while allowing movement of lithium ions therebetween. The separator 12 may be made of, for example, a polyethylene film, a polypropylene film, a polyethylene-polypropylene film, or the like.

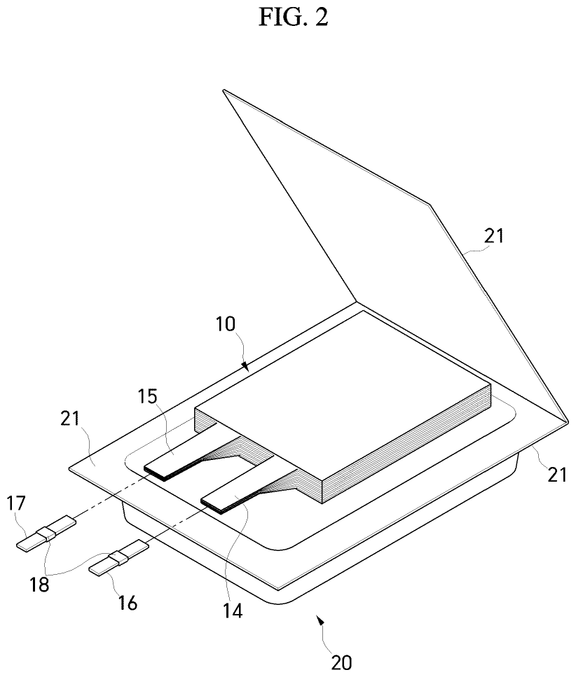

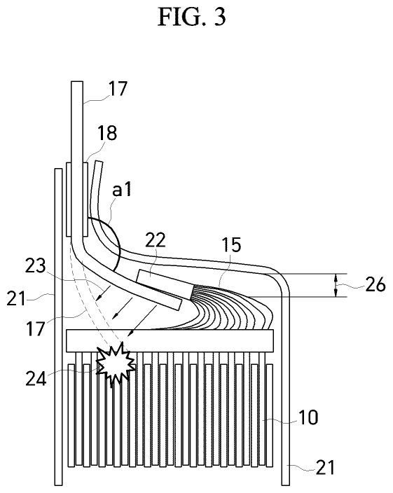

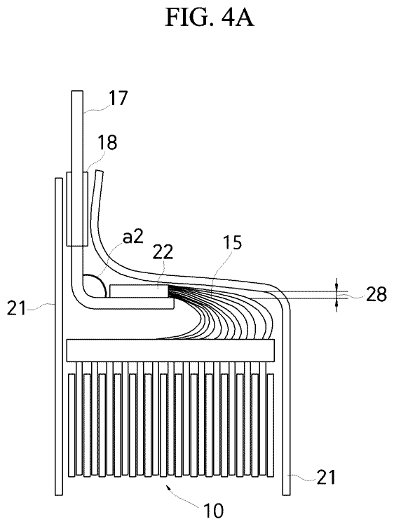

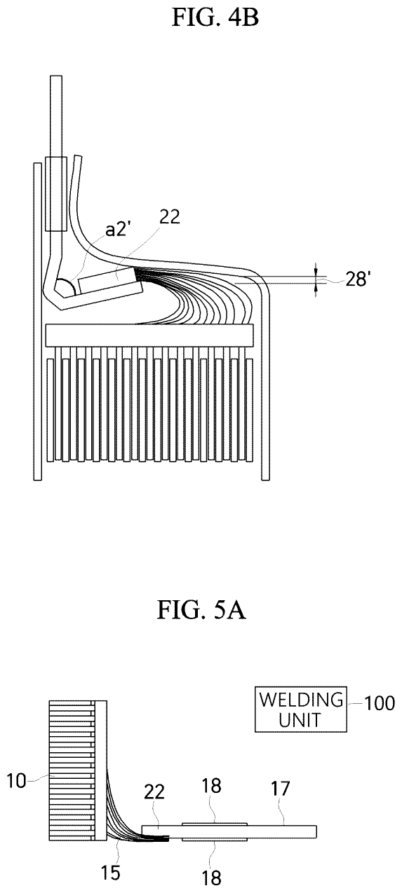

In some embodiments, the electrode assembly 10 may be accommodated in a case along with an electrolyte. In a pouch-type secondary battery, an electrode assembly 10 may be accommodated in a pouch made of flexible material (see, e.g., FIG. 2). In a cylindrical or prismatic secondary battery, an electrode assembly 10 may be accommodated in a cylindrical or prismatic metal casing (see, e.g., FIGS. 3 and 4).

Hereinafter, suitable materials that may be usable for the secondary battery according to embodiments of the present disclosure will be described.

As the positive electrode active material, a compound capable of reversibly intercalating/deintercalating lithium (e.g., a lithiated intercalation compound) may be used. For example, at least one of a composite oxide of lithium and a metal selected from cobalt, manganese, nickel, and combinations thereof may be used.

The composite oxide may be a lithium transition metal composite oxide, and examples thereof may include a lithium-nickel oxide, a lithium-cobalt oxide, a lithium-manganese oxide, a lithium-iron-phosphate compound, a cobalt-free nickel-manganese oxide, or a combination thereof.

As an example, a compound represented by any one of the following formulas may be used: LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}Co_{b}X_{c}O_{2-α}D_{α}(0.90≤a≤1.8, 0≤b≤0.5, 0≤c≤0.5, 0<α<2); LiₐNi_{1-b-c}Mn_{b}X_{c}O_{2-α}D_{α}(0.90≤a≤1.8, 0≤b≤0.5, 0≤c≤0.5, 0<α<2); LiₐNi_{b}Co_{c}L¹ _{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); and LiₐFePO₄ (0.90≤a≤1.8).

In the above formulas: A is Ni, Co, Mn, or a combination thereof; X is Al, Ni, Co, Mn, Cr, Fe, Mg, Sr, V, a rare earth element, or a combination thereof; D is O, F, S, P, or a combination thereof; G is Al, Cr, Mn, Fe, Mg, La, Ce, Sr, V, or a combination thereof; and L¹ is Mn, Al, or a combination thereof.

A positive electrode for a lithium secondary battery may include a substrate and a positive electrode active material layer formed on the substrate. The positive electrode active material layer may include a positive electrode active material and may further include a binder and/or a conductive material.

The content of the positive electrode active material is in a range of about 90 wt % to about 99.5 wt % on the basis of 100 wt % of the positive electrode active material layer, and the content of the binder and the conductive material is in a range of about 0.5 wt % to about 5 wt %, respectively, on the basis of 100 wt % of the positive electrode active material layer.

The substrate may be aluminum (Al), but the material of the substrate may vary.

The negative electrode active material may include a material capable of reversibly intercalating/deintercalating lithium ions, lithium metal, an alloy of lithium metal, a material capable of being doped and undoped with lithium, or a transition metal oxide.

The material capable of reversibly intercalating/deintercalating lithium ions may be a carbon negative electrode active material, which may include, for example, crystalline carbon, amorphous carbon, or a combination thereof. Examples of the crystalline carbon may include graphite, such as natural graphite or artificial graphite, and examples of the amorphous carbon may include soft carbon, hard carbon, a pitch carbide, a meso-phase pitch carbide, sintered coke, and the like.

A Si negative electrode active material or a Sn negative electrode active material may be used as the material capable of being doped and undoped with lithium. The Si negative electrode active material may be silicon, a silicon-carbon composite, SiOₓ (0<x<2), a Si alloy, or a combination thereof.

The silicon-carbon composite may be a composite of silicon and amorphous carbon. According to an embodiment, the silicon-carbon composite may be in the form of a silicon particle and amorphous carbon coated on the surface of the silicon particle.

The silicon-carbon composite may further include crystalline carbon. For example, the silicon-carbon composite may include a core including crystalline carbon and silicon particle and an amorphous carbon coating layer on the surface of the core.

A negative electrode for a lithium secondary battery may include a substrate and a negative electrode active material layer disposed on the substrate. The negative electrode active material layer may include a negative electrode active material and may further include a binder and/or a conductive material.

For example, the negative electrode active material layer may include about 90 wt % to about 99 wt % of a negative electrode active material, about 0.5 wt % to about 5 wt % of a binder, and about 0 wt % to about 5 wt % of a conductive material.

A non-aqueous binder, an aqueous binder, a dry binder, or a combination thereof may be used as the binder. When an aqueous binder is used as the negative electrode binder, a cellulose compound capable of imparting viscosity may be further included.

As the negative electrode substrate, one selected from copper foil, nickel foil, stainless steel foil, titanium foil, nickel foam, copper foam, conductive metal-coated polymer substrate, and combinations thereof may be used.

An electrolyte for a lithium secondary battery may include a non-aqueous organic solvent and a lithium salt.

The non-aqueous organic solvent acts as a medium through which ions involved in the electrochemical reaction of the battery can move.

The non-aqueous organic solvent may be a carbonate, an ester, an ether, a ketone, an alcohol solvent, an aprotic solvent, and may be used alone or in combination of two or more.

In addition, when a carbonate solvent is used, a mixture of cyclic carbonate and chain carbonate may be used.

Depending on the type of lithium secondary battery, a separator may be present between the first electrode plate (e.g., the negative electrode) and the second electrode plate (e.g., the positive electrode). As the separator, polyethylene, polypropylene, polyvinylidene fluoride, or a multilayer film including two or more layers thereof may be used.

The separator may include a porous substrate and a coating layer including an organic material, an inorganic material, or a combination thereof on one or both surfaces of the porous substrate.

The organic material may include a polyvinylidene fluoride polymer or a (meth)acrylic polymer.

The inorganic material may include inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and combinations thereof but the inorganic material may vary.

The organic material and the inorganic material may be mixed in one coating layer or may be in the form of a coating layer including (or containing) an organic material and a coating layer including (or containing) an inorganic material that are stacked on each other.

FIG. 2 is a schematic diagram illustrating a pouch-type secondary battery according to the present disclosure.

The pouch-type secondary battery according to this embodiment may include an electrode assembly 10 and a pouch 20 for accommodating the electrode assembly 10.

As shown in FIG. 2, a first electrode tab 14 and a second electrode tab 15 of the electrode assembly 10 may be electrically connected to a first strip terminal 16 and a second strip terminal 17, respectively, which serve as terminals exposed to the outside. Tab films 18 may be bonded to the first strip terminal 16 and the second strip terminal 17 to insulate a pouch 20 therefrom.

FIG. 3 is a cross-sectional view illustrating a state in which the electrode tabs 15 and the strip terminal 17 of the electrode assembly 10 are bonded to each other in the pouch-type battery and accommodated inside an external pouch 21.

As shown in the drawings, the electrode assembly 10 is accommodated inside the pouch 21 (see FIG. 2), and electrode tabs 15 formed on electrode plates of the electrode assembly 10 are gathered and welded to the strip terminal 17 to form a welded portion 22. The tab film 18 bonded to the strip terminal 17 may be sealed at an outer boundary of the pouch 21, and a portion of the strip terminal 17 may be exposed to the outside.

The electrode tabs 15 and the strip terminal 17 are bent as shown in FIG. 3 and accommodated inside the pouch 21. Generally, as shown in FIG. 3, a bent portion of the strip terminal 17 has a bending angle a1 of an obtuse angle that is greater than 90°. This is because, especially in the case of the stacked electrode assembly 10 shown in FIG. 1, since the plurality of electrode tabs 15 are stacked and then welded to the strip terminal 17, there is a technical limitation in which it is difficult to achieve bending at a right angle or an acute angle smaller than the right angle due to rigidities of the strip terminal 17 and the stacked electrode tabs 15.

In this way, a tensile force is always applied to the strip terminal 17 bent at an obtuse angle in a direction of arrows 23. Therefore, the welded portion 22 with the electrode tabs 15 may be destroyed, and the separated strip terminal 17 may damage the electrode plates and cause a short-circuit 24 between the electrode plates. In addition to this safety problem, due to the bending of the strip terminal 17 at the obtuse angle, an upper internal space 26 of the pouch 21 is more occupied so that a problem of reducing space utilization within the battery occurs. These problems may be exacerbated as the number of electrode plates in the stacked electrode assembly 10 increases along with an increase in battery energy capacity.

In order to solve these problems, a bending method is proposed to make a bent angle of the strip terminal 17 an acute angle that is less than or equal to a right angle (90°) using a relatively simplified process and equipment.

FIG. 4A is a diagram illustrating a bending structure of a strip terminal of the secondary battery according to some embodiments of the present disclosures.

As shown in the drawing, the electrode assembly 10 is accommodated inside the pouch 21, and the electrode tabs 15 (see FIG. 3) formed on the electrode plates constituting the electrode assembly 10 are gathered and welded to the strip terminal 17 to form the welded portion 22. The tab film 18 bonded to the strip terminal 17 may perform a sealing function at the outer boundary of the pouch 21 and also perform an insulating function between the pouch 21 (e.g., an exterior material) and the strip terminal 17. A portion of the strip terminal 17 is exposed to the outside.

The electrode tabs 15 and the strip terminal 17 are bent and accommodated inside the pouch 21. The strip terminal 17 has a bending angle a2 of about 90°. Thus, a separation force applied to the welded portion 22 (see the description of reference numeral 23 in FIG. 3) is reduced so that the welded portion 22 may be stably maintained. In addition, since the strip terminal 17 is bent more compactly than in the case of FIG. 3, an upper space 28 of the pouch 21 is reduced so that the space utilization of the battery can be increased and energy density compared to the same pouch size can be improved.

FIG. 4B is a diagram illustrating a bending structure of a strip terminal of the secondary battery according to some other embodiments of the present disclosure. In the embodiment(s), the strip terminal 17 is bent more compactly than in the case of FIG. 4A to have an acute angle a2′ that is smaller than 90°. Thus, a separation force applied to the welded portion 22 may be further reduced than in the embodiment of FIG. 4A. Even in this embodiment, an upper space 28′ of the pouch 21 is further reduced than in the case of FIG. 3 so that the space utilization of the battery can be increased.

In the embodiments of FIGS. 4A and 4B, the bent portion of the strip terminal 17 may include a portion excluding the welded portion 22. However, for example, the welded portion 22 may be included in the bent portion of the strip terminal 17 so that, when the strip terminal 17 is bent, the welded portion 22 may also be bent.

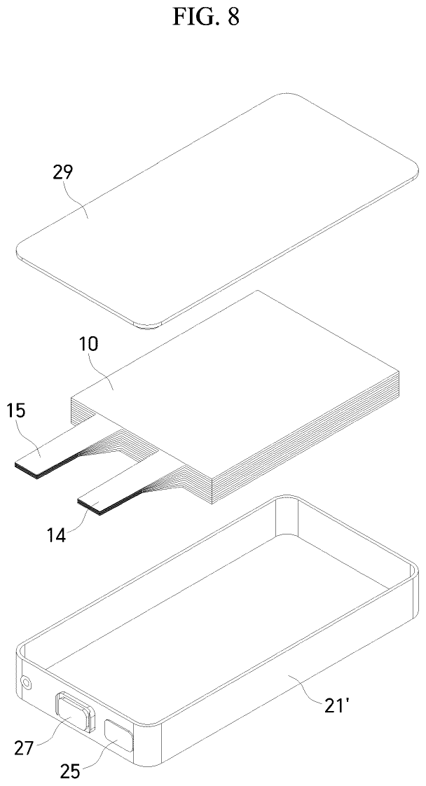

In addition, although the embodiments of FIGS. 4A and 4B relate to the bending structure of the strip terminal applied to an external pouch of a pouch-type secondary battery, according to some other embodiments, the bending structure of the strip terminal may also be applied to an external can of a prismatic secondary battery (see FIG. 8).

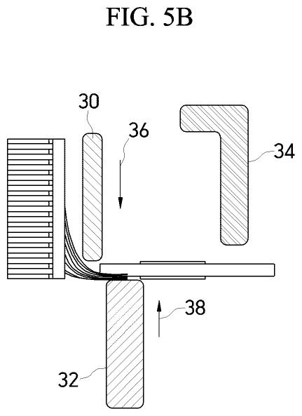

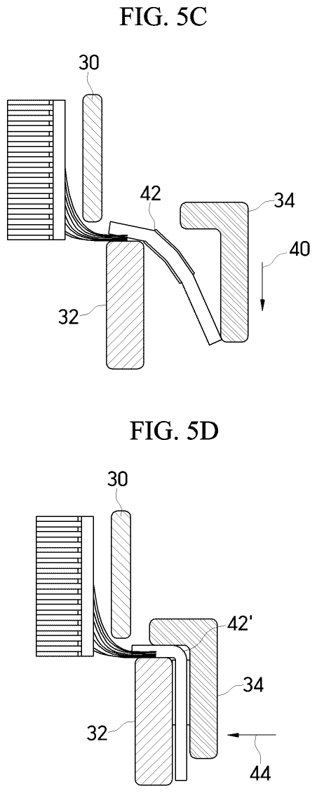

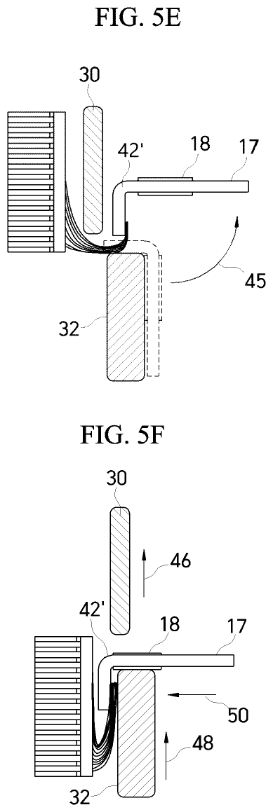

Hereinafter, a method of manufacturing a secondary battery according to some embodiments of the present disclosure will be described. The following method description will be mainly made on the process of bending the strip terminal as described above. FIGS. 5A to 5F are diagrams for describing a method of bending a strip terminal according to some embodiments.

A method of manufacturing a secondary battery according to some embodiments of the present disclosure may include providing an electrode assembly including a plurality of electrode plates with electrode tabs formed thereon, forming a welded portion by welding a strip terminal to the electrode tabs formed on the plurality of electrode plates of the electrode assembly, bending the strip terminal at an angle of about 90° or less, bending the electrode tabs, and accommodating the electrode assembly with the bent strip terminal and the bent electrode tabs into an exterior material. Each operation will be described in detail.

The electrode assembly provided may be the stacked electrode assembly 10 shown in FIG. 1, but a wound-type electrode assembly is also possible. In order to provide the electrode assembly, for example, as described above, a substrate is coated with a positive electrode material and a negative electrode material, and the electrode tabs are formed using a notching unit to manufacture a positive electrode plate and a negative electrode plate. In addition, these electrode plates and a separator may be stacked or wound to manufacture the electrode assembly.

The forming of the welded portion by welding the strip terminal to the electrode tabs of the electrode assembly may be performed using a welding unit (e.g., welding unit 100 in FIG. 5A). The welding unit may bond the plurality of electrode tabs 15 by welding and weld the strip terminal 17 to the welded electrode tabs to form the welded portion 22. The welding unit may include ultrasonic welding equipment or laser welding equipment, but the welding equipment may vary.

In an operation before the bending of the strip terminal 17, the strip terminal 17 may be placed horizontally on a workbench as shown in FIG. 5A. Referring to FIG. 5A, there is the welded portion 22 in which the electrode tabs 15 formed on the electrode plates constituting the electrode assembly 10 and one end of the strip terminal 17 are welded. The above-described tab film 18 may be bonded to the strip terminal 17.

In bending the strip terminal 17 placed as shown in FIG. 5A at an angle of 90° or less as shown in FIG. 4A or 4B, as described above, the bent portion of the strip terminal 17 may be a portion excluding the welded portion 22. However, the welded portion 22 may be included in the bent portion of the strip terminal 17 so that, when the strip terminal 17 is bent, the welded portion 22 may also be bent.

The bending of the strip terminal 17 may be performed as shown in FIGS. 5B to 5D.

First, as shown in FIG. 5B, a support jig 32 applies a rising force 38 to support a lower portion of the welded portion 22 of the strip terminal 17, and a front guide 30 applies a downward force 36 to support upper portions of the electrode tabs 15 in a direction opposite to a direction in which the support jig 32 supports the welded portion 22. A bending jig 34 is waiting above an opposite end of the welded portion 22 of the strip terminal 17. The bending jig 34 may be formed with two arms whose internal angle forms 90° or less. In FIG. 5B, an L-shaped bending jig 34 with two arms having different lengths forming an internal angle of 90° is shown, but the two arms of the bending jig 34 may have the same length, the internal angle formed by the two arms may be 90° or less, and the shape may have another shape (such as a “<” shape, e.g., resembling a “less than” sign) instead of the L shape.

In this way, in a state in which the lower portion of the welded portion 22 is supported by the support jig 32 and the upper portions of the electrode tabs 15 are supported by the front guide 30, the bending jig 34 is moved down as shown in FIG. 5C. The opposite end of the welded portion 22 of the strip terminal 17 is moved down due to the downward force 40 of the bending jig 34, and a bending start portion 42 begins to be formed at a boundary of a region supported by the support jig 32.

Subsequently, as shown in FIG. 5D, the bending jig 34 is moved forward toward the support jig 32. In this case, since the support jig 32 is fixed and the bending jig 34 applies a forward force 44 toward the support jig 32, the strip terminal 17 interposed between the support jig 32 and the bending jig 34 is bent at an angle (90° in the case of FIG. 5D) corresponding to the internal angle (90° or less) of the two arms of the bending jig 34 so that a bending completion portion 42′ is formed.

Next, the bending of the electrode tabs 15 is subsequently performed. In the bending of the electrode tabs 15, the bending jig 34 is moved away from the strip terminal 17 first, and as shown in FIG. 5E, the strip terminal 17 bent at a bending angle of 90° or less is rotated vertically to place the bending completion portion 42′ to an upper position. A jig for a vertical rotation 45 of the strip terminal 17 may be needed.

Subsequently, as shown in FIG. 5F, the front guide 30 is moved up as indicated by arrow 46 and moved away from the position of supporting the electrode tabs 15. Then, the support jig 32 is further moved upward according to arrow 48 to raise the strip terminal 17 and is moved forward according to an arrow 50 toward the electrode assembly 10 to push the welded portion 22 and bend the electrode tabs 15.

Finally, the accommodating of the electrode assembly 10 in which the strip terminal 17 and the electrode tabs 15 are bent into the exterior material may be performed using a conventional exterior material accommodating method. For example, in the case of a pouch-type secondary battery, as shown in FIG. 3, the tab film 18 of the strip terminal 17 may be sealed at an upper boundary of the pouch 21, and a portion of the strip terminal 17 may be exposed to the outside. As another example, in the case of a prismatic secondary battery, the electrode assembly may be inserted into an outer can, such as aluminum or stainless use steel (SUS), and the strip terminal may be welded to an external terminal (see FIG. 8).

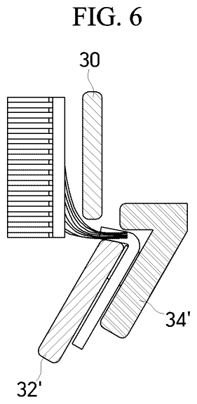

FIG. 6 shows another embodiment of a bending jig and a support jig for the strip terminal according to some embodiments of the present disclosure.

An approximate shape of a bending jig 34′ in which an internal angle formed by two arms constituting the bending jig 34′ is an acute angle of 90° or less, for example, 60°, and a support jig 32′ having a shape corresponding to the approximate shape are shown in FIG. 6. In this way, since the bending angle of the strip terminal 17 is 60°, which is smaller than 90°, the secondary battery may provide the same effect as described above with respect to FIG. 4B.

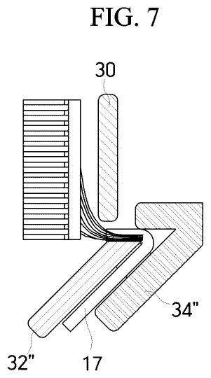

FIG. 7 shows still another embodiment of a bending jig and a support jig for the strip terminal according to the present disclosure.

An approximate shape of a bending jig 34′ in which an internal angle formed by two arms constituting the bending jig 34″ is an acute angle that is further smaller than an acute angle in FIG. 6, for example, 40°, and a support jig 32″ having a shape corresponding to the approximate shape (e.g., the approximate internal shape of the bending jig 34″) are shown in FIG. 7. Therefore, since the bending angle of the strip terminal 17 is 40°, the secondary battery providing the same effect as described above with respect to FIG. 4B can be provided.

The apparatus for manufacturing a secondary battery according to some embodiments of the present disclosure will now be described. The following manufacturing apparatus description will be mainly made on equipment used in the process of bending the strip terminal as described above.

The apparatus for manufacturing a secondary battery according to some embodiments of the present disclosure includes the welding unit configured to form the welded portion 22 by welding the strip terminal 17 to the electrode tabs 15 formed on the plurality of electrode plates included in the manufactured electrode assembly 10, the bending jig 34 configured to bend the strip terminal 17 at a bending angle of 90° or less, and the support jig 32 configured to support the lower portion of the welded portion 22 of the strip terminal 17 when the bending jig 34 bends the strip terminal 17 and push the welded portion 22 of the strip terminal 17 bent by the bending jig 34 toward the electrode assembly 10 to bend the electrode tabs 15.

The welding unit (e.g., welding unit 100 in FIG. 5A) may be equipment for bonding the plurality of electrode tabs 15 by welding and welding the strip terminal 17 to the welded electrode tabs 15 to form the welded portion 22. The welding unit may include ultrasonic welding equipment or laser welding equipment, but the type of welding unit may vary.

The bending jig 34 may bend a portion of the strip terminal 17 excluding the welded portion 22, but this may vary.

In some embodiments, the bending jig 34 may have a shape with two arms forming an inner angle of 90° or less in order to press and bend the strip terminal 17 at a bend angle of 90° or less. For example, FIG. 5B shows the L-shaped bending jig 34 with two arms having different lengths forming an internal angle of 90°, but the two arms of the bending jig 34 may have the same length, the internal angle formed by the two arms may be 90° or less, and the shape may have another shape (such as a “<” shape) instead of the L shape. As another example, FIGS. 6 and 7 illustrate the bending jigs 34′ and 34″ having the two arms with internal angles of 60° and 40°, respectively.

In some embodiments, the support jigs 32, 32′, and 32″ may be configured to support the lower portion of the welded portion 22 of the strip terminal 17 at the same angle as the internal angle formed by the two arms of each of the bending jigs 34, 34′, and 34″.

In some embodiments, a front guide may additionally be used to support the electrode tabs 15 in a direction opposite to the direction in which the support jig 32 supports the welded portion 22.

In some embodiments, a mechanism may be required to move the bending jig 34 away from the strip terminal 17 when the support jig 32 bends the electrode tabs 15.

The secondary battery and the apparatus and method for manufacturing the same according to the above-described embodiments of the present disclosure may be applied to other types of secondary batteries (e.g., prismatic secondary batteries) other than the pouch-type batteries exemplified above.

For example, a prismatic secondary battery shown in FIG. 8 has a structure in which a wide lateral surface of a can 21′ that is an exterior material of a battery is open, the electrode assembly 10 is inserted into the opening, and a cover 29 covers the opening. A first strip terminal and a second strip terminal electrically connected to a first external terminal 27 and a second external terminal 25, which are exposed to the outside of the can 21′, may be connected to the first electrode tabs 14 and the second electrode tabs 15 of the electrode assembly 10 inside the can 21′ by welding, and the first strip terminal and the second strip terminal may be bent by the bending method of the present disclosure described above.

An electrical connection between the electrode assembly and the external terminals may be made by welding electrode tabs formed on the electrode assembly to strip terminals. When the electrode assembly is assembled with the exterior material of the battery (a can or pouch), there are cases in which strip terminals are welded to the electrode tabs formed on electrode plates and the strip terminals are bent. When a bent strip terminal is separated from a welded portion with the electrode tab, a safety problem of the battery may occur, and when a bending angle of the strip terminal is an obtuse angle, a problem of reduced space utilization due to an occupying space inside the exterior material is raised.

According to the present disclosure, since a strip terminal can be bent at an acute angle of 90° or less using a simplified process and equipment, a problem of damaging to an electrode plate caused by separation of the strip terminal due to destruction of a welded portion with the electrode tab can be prevented, and a compact bent portion can be obtained to increase space utilization within a battery.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A secondary battery, comprising:
an exterior material;
an electrode assembly accommodated in the exterior material, the electrode assembly including a plurality of electrode plates on which there are electrode tabs; and
a strip terminal including a welded portion welded to the electrode tabs and a bent portion bent within the exterior material,
wherein a bending angle of the bent portion of the strip terminal is 90° or less.

2. The secondary battery as claimed in claim 1, wherein the bent portion of the strip terminal includes a portion excluding the welded portion.

3. The secondary battery as claimed in claim 1, further comprising a tab film bonded to the strip terminal.

4. The secondary battery as claimed in claim 1, wherein the exterior material is an external pouch of a pouch-type secondary battery.

5. The secondary battery as claimed in claim 1, wherein the exterior material is an external can of a prismatic secondary battery.

6. A method of manufacturing a secondary battery, the method comprising:
providing an electrode assembly including a plurality of electrode plates with electrode tabs formed thereon;
forming a welded portion by welding a strip terminal to the electrode tabs formed on the plurality of electrode plates of the electrode assembly;
bending the strip terminal at an angle of 90° or less, resulting in a bent strip terminal;
bending the electrode tabs, resulting in bent electrode tabs; and
accommodating the electrode assembly with the bent strip terminal and the bent electrode tabs inside an exterior material.

7. The method as claimed in claim 6, wherein bending the strip terminal at the angle of 90° or less includes bending a portion excluding the welded portion.

8. The method as claimed in claim 6, wherein bending the strip terminal at the angle of 90° or less includes:
supporting the welded portion with a support jig; and
bending the strip terminal at a bending angle of 90° or less by pressing the strip terminal with a bending jig having two arms forming an internal angle of 90° or less.

9. The method as claimed in claim 8, wherein bending the strip terminal at the angle of 90° or less further includes supporting the electrode tabs with a front guide in a direction opposite to a direction in which the support jig supports the welded portion.

10. The method as claimed in claim 6, wherein bending the electrode tabs includes pushing the welded portion of the strip terminal bent at a bending angle of 90° or less toward the electrode assembly.

11. The method as claimed in claim 6, wherein accommodating the electrode assembly inside the exterior material includes accommodating the electrode assembly in an external pouch of a pouch-type secondary battery.

12. The method as claimed in claim 6, wherein accommodating the electrode assembly inside the exterior material includes accommodating the electrode assembly in an external can of a prismatic secondary battery.

13. An apparatus for manufacturing a secondary battery, the apparatus comprising:
a welding unit configured to form a welded portion by welding a strip terminal to electrode tabs formed on a plurality of electrode plates included in an electrode assembly;
a bending jig configured to bend the strip terminal at a bending angle of 90° or less; and
a support jig configured to support the welded portion of the strip terminal when the bending jig bends the strip terminal and push the welded portion of the strip terminal bent by the bending jig toward the electrode assembly to bend the electrode tabs.

14. The apparatus as claimed in claim 13, wherein the bending jig bends a portion of the strip terminal excluding the welded portion.

15. The apparatus as claimed in claim 13, wherein the bending jig includes two arms having an internal angle of 90° or less in order to press and bend the strip terminal at the bending angle of 90° or less.

16. The apparatus as claimed in claim 13, further comprising a front guide configured to support the electrode tabs in a direction opposite to a direction in which the support jig supports the welded portion.

17. The apparatus as claimed in claim 13, wherein the bending jig is configured to be moved away from the strip terminal when the support jig bends the electrode tabs.

18. The apparatus as claimed in claim 15, wherein the support jig is configured to support a lower portion of the welded portion of the strip terminal at a same angle as the internal angle of the bending jig.
